(19) United States
(12) Patent Application Publication
(10) Pub. No.: US 2014/0167425 A1
(43) Pub. Date: Jun. 19, 2014

(54) KEYLESS LOCKING SYSTEM

(71) Applicant: HOL SPECIAL PARTS PTY LTD, Moorabbin (AU)

(72) Inventors: Mohammad Omer Dost, ENDEAVOUR HILLS (AU); Mohammad Masood Aimaq, ST KILDA EAST (AU)

(73) Assignee: HOL SPECIAL PARTS PTY LTD, MOORABBIN (AU)

(21) Appl. No.: 13/717,409

(22) Filed: Dec. 17, 2012

(51) Int. Cl. E05B 65/12

(52) U.S. Cl. CPC E05B 83/18
USPC 292/201

(57) ABSTRACT

The present invention provides a keyless locking system comprising a keyless locking mechanism mountable to a cover of a tray compartment of a vehicle having a mechanical trigger and a mechanical override mechanism having an actuator operable via a cable connected to a lever located within a cabin of the vehicle, the actuator moveable to engage the mechanical trigger enabling mechanical activation of the latch.

### FIELD OF THE INVENTION

The present invention relates to locking systems for vehicles. In particular, but not exclusively, the present invention relates to a keyless locking system for utility and tray back style motor vehicles fitted with hard top covers or lockable compartments.

### BACKGROUND TO THE INVENTION

Utility and tray back style motor vehicles fitted with hardtop tonneau covers are generally lockable via a manual key-operated cam lock system. However, these manual locking systems can be cumbersome and prone to unauthorised access to the tray compartment from the exterior of the vehicle.

There have been various keyless locking systems designed for connection to the central locking system of a motor vehicle or as a stand-alone system of operation which can be retrofitted into any vehicle. Motor vehicles without central locking can be fitted with a stand-alone system with key fob.

However, keyless locking systems on utility or tray back style motor vehicles with lockable hard top tonneau covers are problematic due to the fact that if a failure occurs, access to the rear cannot be gained without a failsafe system and the tailgate cannot be opened until the hard top tonneau is lifted. The failsafe mechanism uses the originally manually key operated cam locks fitted to the hard top tonneau cover which introduces the risk of unauthorised access to the tray compartment.

### OBJECT OF THE INVENTION

It is a preferred object of the present invention to provide a keyless locking system for accessing a tray compartment of a vehicle which provides a manual override release mechanism that cannot be accessed from the exterior of the vehicle, that addresses or at least ameliorates one or more of the aforementioned problems of the prior art.

It is a preferred object of the present invention to provide a keyless locking system which is simple to install and easy to use.

### SUMMARY OF THE INVENTION

Generally, embodiments of the present invention relate to a keyless locking system for accessing a tray compartment of vehicle.

According to one aspect, although not necessarily the broadest or only aspect, embodiments of the present invention reside in a keyless locking system comprising:

a keyless locking mechanism mountable to a cover of a tray compartment of a vehicle having a mechanical trigger; and

a mechanical override mechanism having an actuator operable via a cable connected to a lever located within a cabin of the vehicle, the actuator moveable to engage the mechanical trigger enabling mechanical activation of the latch.

Preferably, the keyless locking mechanism is mounted to an underside of the cover of the tray compartment of the vehicle via a mounting bracket assembly.

Preferably, the actuator is a striker plate.

Preferably, a first end of the cable is coupled to the striker plate mounted to a mounting plate of the mounting bracket assembly and a second end of the cable is coupled to the lever.

Preferably, the keyless locking mechanism further comprises an electronic rotary latch engageable with a striker bolt mounted on the tray compartment to lock the cover in a closed position.

Further features and forms of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1 is a perspective view of a keyless locking system according to embodiments of the present invention;

FIG. 2 is a perspective view of the keyless locking mechanism of the keyless locking system of FIG. 1;

FIG. 3 is a side sectional view of the keyless locking system of FIG. 1;

FIG. 4 is a top plan view of the keyless locking system of FIG. 1; and

FIG. 5 is a schematic drawing of the keyless locking system of FIG. 1.

Skilled addressees will appreciate that elements in the drawings are illustrated for simplicity and clarity and have not necessarily been drawn to scale. For example, the relative dimensions of some of the elements in the drawing may be distorted to help improve understanding of embodiments of the present invention.

### DETAILED DESCRIPTION OF THE INVENTION

Embodiments of the present invention provide a keyless locking system for accessing a tray compartment of a vehicle, which provides a manual override release mechanism that cannot be accessed from the exterior of the vehicle. The keyless locking system of the present invention is intended to be utilised with a tray compartment or rear compartment of a utility motor vehicle or other tray back style motor vehicle having a lockable hard cover or lid, often referred to as a ‘tonneau’ cover. However, it should be appreciated that embodiments of the present invention can be modified to provide a keyless locking system for other suitable compartments of a vehicle.

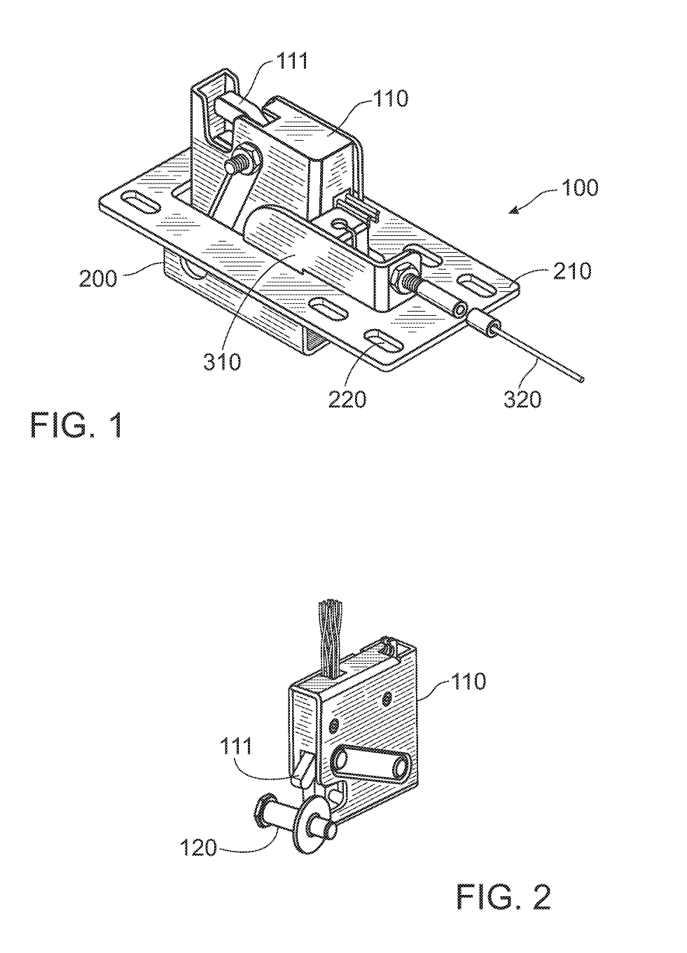

Referring to FIG. 1, the keyless locking system 100 is provided in accordance with embodiments of the present invention. According to some embodiments of the invention, the keyless locking system 100 comprises a keyless locking mechanism 110 mountable to an underside of a hard cover or lid of a tray compartment via a mounting bracket assembly. The mounting bracket assembly 200 comprises a mounting plate 210 having at least one aperture 220 for receiving a fastener such as a screw or the like to mount the mounting plate 210 to the underside of the tonneau cover or lid.

The keyless locking mechanism 110 comprises an electronic rotary latch 111 which eliminates key management and is operable via access control signals provided from a suitable access control device (not illustrated) including key fobs, keypads and proximity cards. The keyless locking mechanism 110 comprises a microprocessor controlled gearmotor (not illustrated) for moving the latch 111 between a first “engaged” position shown in FIG. 1 and a second “disengaged” position shown in FIG. 2. Referring to FIG. 2, a striker bolt 120 is mounted to a side wall of the tray compartment of the vehicle. The latch 111 engages with the striker bolt 120 to lock the tonneau cover in a closed position.

Upon activation via the access control device, the access control signal momentarily unlocks and releases a spring loaded cam which rotates the latch 111 outwardly to release the striker bolt 120 and push the tonneau cover or lid open. The latch 111 immediately returns to the locked state ready to re-lock upon closing the cover or lid. Closing the cover or lid will engage the striker bolt 120 with the latch 111. It is envisaged that any suitable keyless locking mechanism 110 can be employed to fulfill the requirements of the present invention.

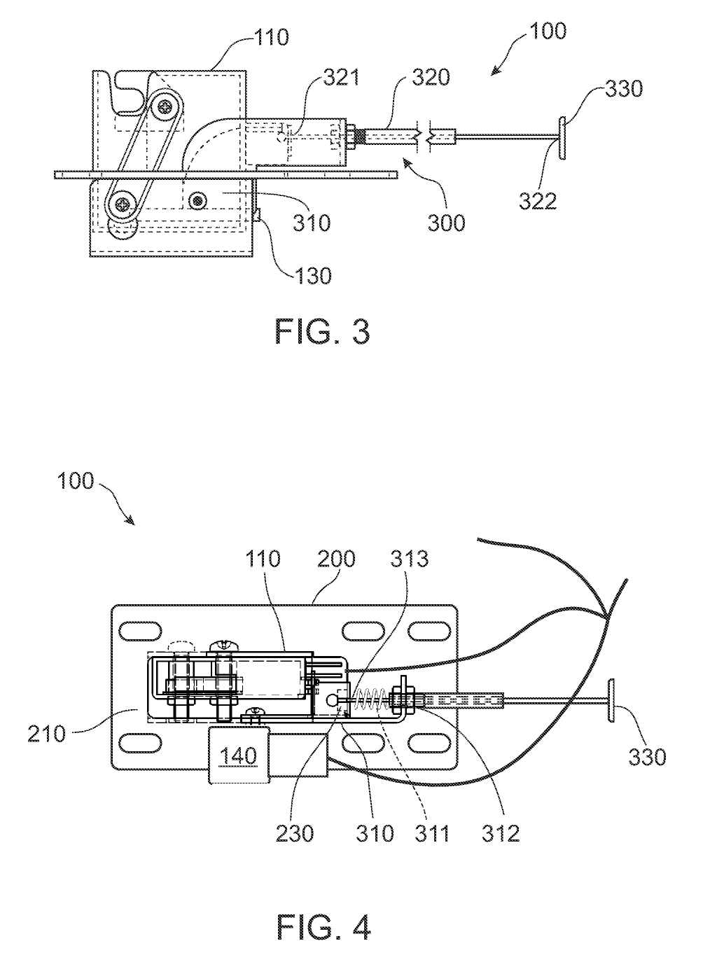

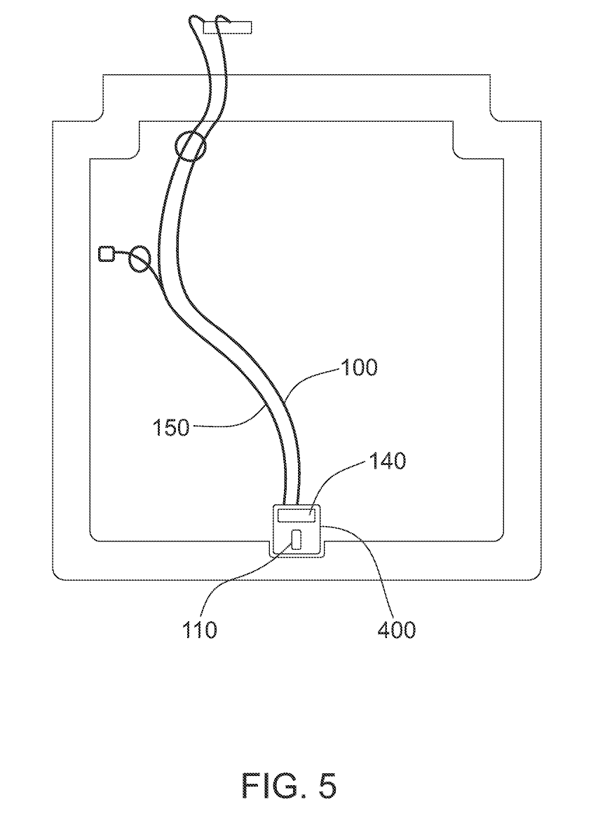

Referring now to FIG. 3, the keyless locking mechanism 110 comprises a cable-based mechanical override mechanism 300 for enabling mechanical actuation of the electronic latch 111. The mechanical override mechanism 300 comprises a striker plate 310 movable to engage with and activate a mechanical trigger 130 provided on the keyless locking mechanism 110. The striker plate 310 is movable via a cable 320. A first end 321 of the cable 320 is coupled to a non-contacting end of the striker plate 310 and a second end 322 of the cable 320 is coupled to a lever 330. The lever 330 is located within an interior cabin of the vehicle such that unauthorised access from the exterior of the vehicle is prevented. In the event of a power failure, the user can still enter the vehicle using a key and pull on the lever to release the tonneau cover and gain access to the tray compartment. Accordingly, the cable should be of a suitable length to enable the cable to be secured at a desired position within the cabin of the vehicle.

As illustrated in FIG. 4, the striker plate 310 of the override mechanism 300 is biased in a first position via a spring 311 wherein the mechanical trigger is in a “locked” position. A first end 312 of the spring 311 is coupled to the non-contacting end of the striker plate 310 and a second end 313 of the spring 311 is coupled to a bracket 230 provided on the mounting plate 210 of the mounting bracket assembly 200. Pulling the lever 330 and cable 320 moves the striker plate 310 from a first position to a second position displacing the mechanical trigger into a “release” position enabling mechanical activation of the latch 111 to release the tonneau cover. Upon release of the lever 330, the striker plate 310 will automatically return to the first position.

The keyless locking mechanism 110 is coupled to a relay 140 which provides a delayed release/locking mechanism for the tonneau cover. The relay provides a predetermined timed release such that the cover will automatically lock after the predetermined time has expired. For example, the locking mechanism 110 will return to a locked position after forty-five seconds regardless of whether the tonneau cover is in an open or closed position.

Referring to FIG. 4, a housing 400 is positioned over the mounting bracket assembly 200 to house at least some of the components of the keyless locking system 100. A wiring loom 150 is passed through the housing to electronically couple the locking mechanism 110 to the relay 140 and the locking mechanism 110 to a power source of the vehicle. The wiring loom 150 can also be used to power a light fitted within the housing which is activated upon the release of the tonneau cover to provide visibility for the tray compartment when the tonneau cover is opened.

Hence, the keyless locking system 100 of the present invention thus provides a solution to the aforementioned problems of the prior art by providing a keyless locking system for accessing a tray compartment of a vehicle which provides a manual override release mechanism that cannot be accessed from the exterior of the vehicle. In the event of a power failure, the system provides fully redundant access to the vehicle compartment. The keyless locking system of the present invention is simple and easy to install and can be retrofitted into any suitable vehicle.

Throughout this specification and claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or step.

The reference to any prior art in this specification is not, and should not be taken as, an acknowledgement or any form or suggestion that the prior art forms part of the common general knowledge in Australia.

Throughout the specification the aim has been to describe the invention without limiting the invention to any one embodiment or specific collection of features. Persons skilled in the relevant art may realize variations from the specific embodiments that will nonetheless fall within the scope of the invention.

What is claimed is:

1. A keyless locking system comprising:
a keyless locking mechanism mountable to a cover of a tray compartment of a vehicle having a mechanical trigger; and
a mechanical override mechanism having an actuator operable via a cable connected to a lever located within a cabin of the vehicle, the actuator moveable to engage the mechanical trigger enabling mechanical activation of the latch.

2. The keyless locking system of claim 1, wherein the keyless locking mechanism is mounted to an underside of the cover of the tray compartment of the vehicle via a mounting bracket assembly.

3. The keyless locking system of claim 1, wherein the actuator is a striker plate.

4. The keyless locking system of claim 3, wherein a first end of the cable is coupled to the striker plate mounted to a mounting plate of the mounting bracket assembly and a second end of the cable is coupled to the lever.

5. The keyless locking system of claim 1, wherein the keyless locking mechanism further comprises an electronic rotary latch engageable with a striker bolt mounted on the tray compartment to lock the cover in a closed position.
